(19) United States
(12) Patent Application Publication
(10) Pub. No.: US 2025/0319761 A1
(43) Pub. Date: Oct. 16, 2025

(54) COOLING DEVICE AND VEHICLE INCLUDING THE SAME

(71) Applicants: Hyundai Motor Company, Seoul (KR); Kia Corporation, Seoul (KR)

(72) Inventor: Myung Hwan Kim, Hwaseong (KR)

(21) Appl. No.: 18/889,234

(22) Filed: Sep. 18, 2024

(30) Foreign Application Priority Data
Apr. 15, 2024 (KR) 10-2024-0050222

(51) Int. Cl. B60K 11/08; F28D 1/053; F28D 21/00

(52) U.S. Cl. CPC B60K 11/08; F28D 1/05358; F28D 2021/008

(57) ABSTRACT

A cooling device for a vehicle includes an inlet body into which outside air is introduced, a heat exchange member provided at one side of the inlet body, and an outlet body including an outlet region provided at one side of the heat exchange member, in which a direction in which the outside air is introduced into the inlet body, a direction in which the outside air is introduced into the heat exchange member, and a direction in which the outside air is discharged from the outlet body intersect one another.

### CROSS-REFERENCE TO RELATED APPLICATION

This application claims under 35 U.S.C. § 119 (a) the benefit of Korean Patent Application No. 10-2024-0050222 filed in the Korean Intellectual Property Office on Apr. 15, 2024, the entire contents of which are incorporated herein by reference.

### BACKGROUND

### (a) Technical Field

The present disclosure relates to a cooling device and a vehicle including the same, more particularly, to a cooling device for a vehicle that is capable of being used in an air-cooled manner.

### (b) Description of the Related Art

An electric vehicle, which operates by using electrical energy of a battery as a power source, needs to effectively dissipate heat generated from the battery as well as heat generated from a motor that operates wheels of the electric vehicle. In many cases, a radiator is mounted in the electric vehicle to recover heat from heat generation components, including the battery and the motor, and discharge the heat to an outside of the vehicle. Meanwhile, in order to meet increasing demands for aesthetic design of vehicles, studies are being actively conducted to improve the aesthetic appearances of an electric vehicle.

However, in the related art, in case that the radiator is mounted in the vehicle, a volume occupied by the radiator severely restricts the design of the vehicle. In particular, the radiator is often disposed to face a front surface of the vehicle to effectively introduce outside air into the radiator while the vehicle travels, which significantly degrades spatial utilization of a central region of the vehicle based on a leftward/rightward direction.

### SUMMARY

The present disclosure has been made in an effort to improve a degree of freedom related to spatial utilization of a vehicle by ensuring heat exchange performance even though a radiator is disposed without facing a front surface of the vehicle.

In order to achieve the above-mentioned object, one aspect of the present disclosure provides a cooling device for a vehicle including: an inlet body including an inlet region, which is opened toward an outside of the vehicle, and having therein a first space that communicates with the inlet region; a heat exchange member provided at one side of the inlet body and having a heat exchange region that communicates with the first space; and an outlet body provided at one side of the heat exchange member, having therein a second space configured to communicate with the heat exchange region, and including an outlet region opened toward the outside, in which a direction extending perpendicularly to an imaginary plane formed in parallel with the inlet region is defined as a first normal direction, a direction extending perpendicularly to an imaginary plane formed in parallel with the outlet region is defined as a second normal direction, and a direction in which the heat exchange member faces the inlet body or the outlet body is defined as a facing direction, and in which the first normal direction, the second normal direction, and the facing direction intersect one another.

The inlet body may include a region recessed toward the first space.

The inlet body and the outlet body may be provided to face each other with the heat exchange member interposed therebetween.

A direction perpendicular to the first normal direction and the facing direction may be defined as an upward/downward direction, the inlet body may include: an inlet lower surface configured to define a lower surface of the inlet body; an inlet upper surface provided to be spaced apart upward from the inlet lower surface; and an inlet lateral surface configured to connect the inlet lower surface and the inlet upper surface, and the inlet lateral surface may include a first inlet lateral surface including a shape convexly protruding outward.

The inlet upper surface may include a shape recessed toward the first space.

A cross-section, which is made by cutting the inlet upper surface in a direction perpendicular to the first normal direction, may include a curved shape recessed inward.

A cross-section, which is made by cutting the inlet upper surface in a direction perpendicular to the facing direction, may include a line segment shape.

An upper end of the first inlet lateral surface may include a section having a gradient that increases as the section becomes closer to the heat exchange member.

The inlet lateral surface may further include a second inlet lateral surface provided to face the first inlet lateral surface with the inlet upper surface interposed therebetween, and the second inlet lateral surface may include a flat shape.

The other end of the second inlet lateral surface, which is opposite to one end facing the heat exchange member, may be connected to the first inlet lateral surface.

The cooling device may further include: one or more division wall members provided inside the inlet body and protruding upward from the inlet lower surface, in which the division wall member extends from the inlet region toward the heat exchange member.

The division wall member may extend in parallel with the first inlet lateral surface.

The division wall member may extend from the inlet lower surface to the inlet upper surface.

The division wall member may extend from the inlet lower surface and be provided to be spaced apart from the inlet upper surface.

The division wall member may include: a section extending from the inlet lower surface to the inlet upper surface; and a section extending from the inlet lower surface and provided to be spaced apart from the inlet upper surface.

A width of the division wall member in the upward/downward direction may be constant.

The cooling device may further include: a partition member extending from the division wall member and configured to partition the first space in the upward/downward direction.

The outlet body may include an outlet lateral surface configured to define a lateral surface of the outlet body, and the outlet lateral surface may include a shape convex outward.

The inlet lower surface may include a shape recessed toward the first space.

A vehicle may include the above-described cooling device.

In order to achieve the above-mentioned object, another aspect of the present disclosure provides a vehicle including: a cooling device; and a frame on which the cooling device is mounted, in which the cooling device includes: an inlet body including an inlet region, which is opened toward an outside of the vehicle, and having therein a first space that communicates with the inlet region; a heat exchange member provided at one side of the inlet body and having a heat exchange region that communicates with the first space; and an outlet body provided at one side of the heat exchange member, having therein a second space configured to communicate with the heat exchange region, and including an outlet region opened toward the outside, in which the inlet body includes a region recessed toward the first space, and in which the recessed region of the inlet body is provided to face a central region of the frame based on a leftward/rightward direction.

According to the present disclosure, the heat exchange performance may be ensured even though the radiator is disposed without facing the front surface of the vehicle, which may remarkably improve the degree of freedom related to the spatial utilization of the vehicle.

### BRIEF DESCRIPTION OF THE DRAWINGS

FIG. 1 is a front view illustrating a part of an internal structure of a vehicle according to the present disclosure.

FIG. 2 is a perspective view of a cooling device according to a first embodiment of the present disclosure.

FIG. 3 is a top plan view of the cooling device according to the first embodiment of the present disclosure.

FIG. 4 is a front view of the cooling device according to the first embodiment of the present disclosure.

FIG. 5 is a perspective view of a cooling device according to a second embodiment of the present disclosure.

FIG. 6 is a top plan view of the cooling device according to the second embodiment of the present disclosure.

FIG. 7 is a perspective view of a cooling device according to a third embodiment of the present disclosure.

FIG. 8 is a perspective view of an inlet body provided in a cooling device according to a fourth embodiment of the present disclosure.

FIG. 9 is an enlarged view illustrating regions partitioned by partition members and division wall members of the inlet body provided in the cooling device according to the fourth embodiment of the present disclosure.

FIG. 10 is a front view of a cooling device according to a fifth embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, a cooling device and a vehicle according to the present disclosure will be described with reference to the drawings.

### Cooling Device

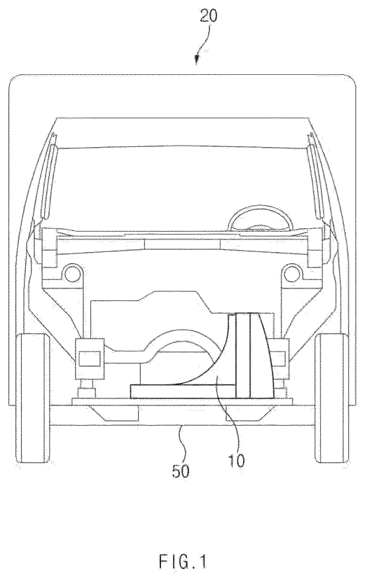

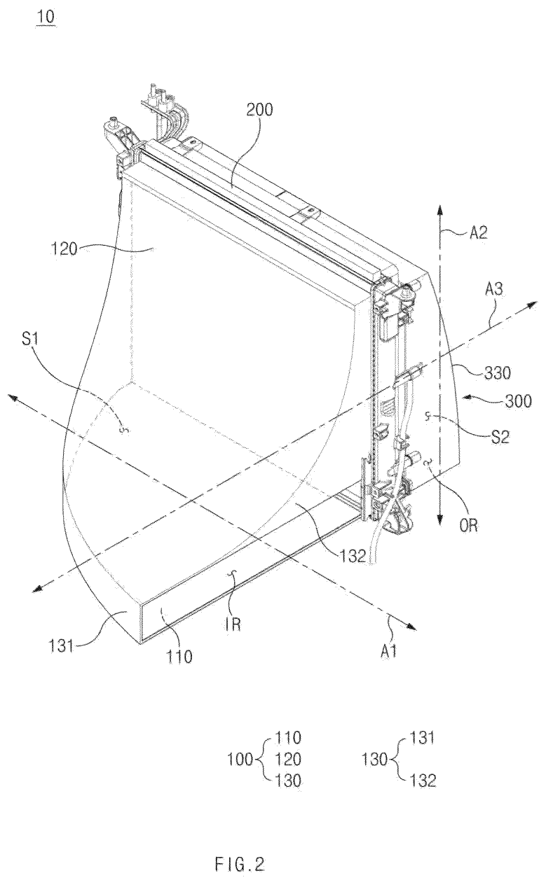

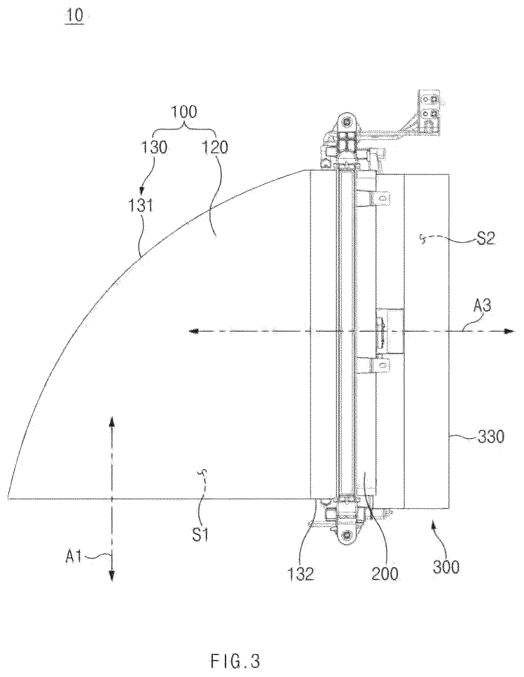

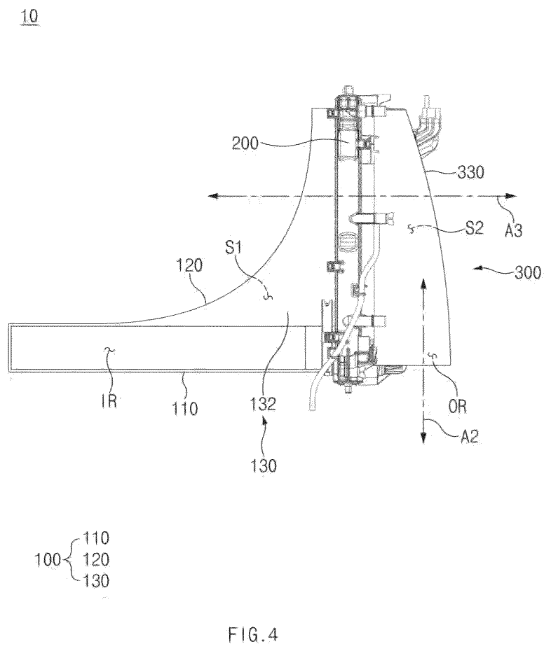

FIG. 1 is a front view illustrating a part of an internal structure of a vehicle according to the present disclosure, and FIG. 2 is a perspective view of a cooling device according to a first embodiment of the present disclosure. FIG. 3 is a top plan view of the cooling device according to the first embodiment of the present disclosure, and FIG. 4 is a front view of the cooling device according to the first embodiment of the present disclosure.

With reference to FIGS. 1 to 4, a cooling device 10 according to the present disclosure may be configured to receive outside air and cool an internal configuration of a vehicle 20. For example, the cooling device 10 may transfer heat, which is generated from motorized components, such as a battery, mounted in the vehicle, to air supplied to the cooling device and discharge the air from the cooling device, thereby cooling the motorized components. In particular, the cooling device 10 according to the present disclosure is configured such that a region into which outside air is introduced is directed toward a front side of the vehicle 20, such that outside air may be effectively introduced into the cooling device while the vehicle travels, and a space occupied by the cooling device 10 in a leftward/rightward direction of the vehicle 20 may be minimized, which may improve the utilization of the internal space of the vehicle.

With reference to FIG. 2, the cooling device 10 according to the present disclosure may include an inlet body 100 including an inlet region IR, which is opened toward the outside, and having therein a first space S1 configured to communicate with the inlet region IR. The inlet region IR may be understood as a region that provides a route through which outside air is introduced into the first space S1 in the inlet body 100.

The cooling device 10 according to the present disclosure may further include a heat exchange member 200 provided at one side of the inlet body 100 and having a heat exchange region that communicates with the first space S1. That is, outside air, which is introduced into the first space S1 of the inlet body 100 through the inlet region IR, may recover thermal energy while passing through the heat exchange region of the heat exchange member 200 and then be discharged back to the outside. The inlet body 100 may be fixedly coupled to the heat exchange member 200. For example, as illustrated in FIGS. 2 to 4, the heat exchange member 200 may have an approximate plate shape. A cooling fluid, which recovers heat while passing through a heat generation component such as a motorized component, may be introduced into the heat exchange member 200 together with outside air. In this case, the outside air and the cooling fluid may exchange heat with each other in the heat exchange member 200, such that the outside air may be heated, and the cooling fluid may be cooled. The description of the contents related to a heat exchange mechanism occurring in the heat exchange member 200 may be replaced with the description of the contents that are publicly known in the related art in terms of heat exchangers for a vehicle or radiators for a vehicle.

Meanwhile, the cooling device 10 according to the present disclosure may further include an outlet body 300 provided at one side of the heat exchange member 200 and having therein a second space S2 that communicates with the heat exchange region, and the outlet body 300 may include an outlet region OR opened toward the outside. More specifically, the second space S2 may communicate with the outlet region OR. Therefore, the outside air, which is discharged from the heat exchange region, may pass through the second space S2 and then be discharged to the outside through the outlet region OR. Meanwhile, as illustrated in FIGS. 2 to 4, the inlet body 100 and the outlet body 300 may be provided to face each other with the heat exchange member 200 interposed therebetween. More specifically, the inlet body 100 and the outlet body 300 may be spaced apart from each other in a thickness direction of the heat exchange member 200 or a facing direction A3.

Meanwhile, with reference to FIGS. 2 to 4, in the present specification, a direction extending perpendicularly to an imaginary plane formed in parallel with the inlet region IR is defined as a first normal direction A1, a direction extending perpendicularly to an imaginary plane formed in parallel with the outlet region OR is defined as a second normal direction A2, and a direction in which the heat exchange member 200 faces the inlet body 100 or the outlet body 300 is defined as the facing direction A3. The first normal direction A1 may be understood as an average flow direction of outside air when the outside air is introduced into the inlet region IR. The second normal direction A2 may be understood as an average flow direction of outside air when the outside air is discharged from the outlet region OR. The facing direction A3 may be understood as an average flow direction of outside air in the heat exchange member 200. In case that the heat exchange member 200 has a plate shape, the facing direction A3 may be a thickness direction of the heat exchange member.

In this case, the cooling device 10 according to the present disclosure may be configured such that a direction in which the outside air introduced into the cooling device 10 flows in the inlet body 100, a direction in which the outside air flows in the heat exchange member 200, and a direction in which the outside air flows in the outlet body 300 are different from one another. That is, with reference to FIGS. 2 to 4, the first normal direction A1, the second normal direction A2, and the facing direction A3 may intersect one another. More particularly, the first normal direction A1, the second normal direction A2, and the facing direction A3 may be perpendicular to one another. For example, the first normal direction A1 may be a forward/rearward direction, the second normal direction A2 may be an upward/downward direction, and the facing direction A3 may be a leftward/rightward direction.

With reference to the above-mentioned description, according to the present disclosure, a direction in which outside air is introduced into the cooling device 10 and a direction in which the outside air introduced into the cooling device 10 passes through the heat exchange member 200 may intersect each other. For example, in case that the direction in which the outside air is introduced into the cooling device 10 is the forward/rearward direction, the direction in which the outside air introduced into the cooling device 10 passes through the heat exchange member 200 may be the leftward/rightward direction, and a direction in which the outside air is discharged from the outlet body 300 when the outside air introduced into the cooling device 10 is discharged back to the outside may be the upward/downward direction. Therefore, the heat exchange member 200 may be disposed in the vehicle so that the thickness direction of the heat exchange member 200 is parallel to the leftward/rightward direction of the vehicle. Therefore, according to the present disclosure, it is possible to minimize an area occupied by the cooling device 10 in the leftward/rightward direction of the vehicle in case that the cooling device 10 is disposed in the vehicle 20, which may maximize the utilization of the internal space of the vehicle.

Hereinafter, a specific shape of the cooling device 10 will be described in detail with reference to the drawings.

With reference to FIGS. 2 to 4, the inlet body 100 may include a region recessed toward the first space S1. More specifically, in case that the cooling device 10 is mounted in the vehicle 20, the outlet body 300 of the cooling device 10 may be positioned outward based on the leftward/rightward direction of the vehicle 20, and the inlet body 100 of the cooling device 10 may be positioned inward based on the leftward/rightward direction of the vehicle 20. In this case, in case that the inlet body 100 has a shape recessed toward the first space S1, a volume occupied by the inlet body 100 in the inner region based on the leftward/rightward direction of the vehicle may be further reduced.

Meanwhile, an outer surface of the inlet body 100, which defines the first space S1, may be divided into a plurality of regions.

More specifically, in case that the direction perpendicular to the first normal direction A1 and the facing direction A3 is defined as the upward/downward direction, the inlet body 100 may include an inlet lower surface 110 configured to define a lower surface of the inlet body, an inlet upper surface 120 spaced apart upward from the inlet lower surface 110, and an inlet lateral surface 130 configured to connect the inlet lower surface 110 and the inlet upper surface 120. In this case, according to the present disclosure, the inlet upper surface 120 may include a shape recessed toward the first space S1, and the inlet lateral surface 130 may include a first inlet lateral surface 131 including a shape convexly protruding outward. The configuration in which the inlet upper surface 120 includes the shape recessed toward the first space S1 is provided to reduce the volume occupied by the inlet body 100 in the inner region based on the leftward/rightward direction of the vehicle, as described above. In contrast, the configuration in which the first inlet lateral surface 131 includes the shape convexly protruding outward is provided to allow the first inlet lateral surface 131 to serve to guide the outside air to the heat exchange member 200 while the outside air introduced into the first space S1 through the inlet region IR flows to the heat exchange member 200. More specifically, the first inlet lateral surface 131 may be provided to generally face the inlet region IR with the first space S1 interposed therebetween. Therefore, at least a part of the outside air introduced into the first space S1 through the inlet region IR may reach an inner surface of the first inlet lateral surface 131 and then be introduced into the heat exchange member 200 while flowing along the inner surface of the first inlet lateral surface 131. For example, as illustrated in FIGS. 2 to 4, the inlet upper surface 120 may include a region having a shape recessed toward the first space S1, and a region having a flat shape in the horizontal direction. The entire region of the first inlet lateral surface 131 may have a shape convexly protruding outward.

Meanwhile, as described above, the inlet upper surface 120 may include the shape recessed toward the first space S1. However, a cross-sectional shape of the inlet upper surface 120 may vary depending on the directions in which the cross-sections are formed.

That is, with reference to FIGS. 2 to 4, a cross-section, which is made by cutting the inlet upper surface 120 in a direction perpendicular to the first normal direction A1, may include a curved shape recessed inward. In contrast, a cross-section, which is made by cutting the inlet upper surface 120 in a direction perpendicular to the facing direction A3, may include a line segment shape. More particularly, the cross-section, which is made by cutting the inlet upper surface 120 in the direction perpendicular to the first normal direction A1, may include a region having a curved shape recessed inward, and a region having a line segment shape extending in the horizontal direction. The entire region of the cross-section, which is made by cutting the inlet upper surface 120 in the direction perpendicular to the facing direction A3, may have a line segment shape.

Meanwhile, the first inlet lateral surface 131 is configured to connect the inlet lower surface 110 and the inlet upper surface 120. Therefore, in case that the inlet upper surface 120 has the above-mentioned shape, a shape of an upper end of the first inlet lateral surface 131 may also correspond to the above-mentioned shape. More specifically, the upper end of the first inlet lateral surface 131 may include a section having a gradient that increases as the section becomes closer to the heat exchange member 200. More specifically, the upper end of the first inlet lateral surface 131 may include a section having a gradient that increases as the section becomes closer to the heat exchange member 200, and a section extending in the horizontal direction.

Meanwhile, the inlet lateral surface 130 may further include a second inlet lateral surface in addition to the first inlet lateral surface 131. More specifically, the inlet lateral surface 130 may further include a second inlet lateral surface 132 provided to face the first inlet lateral surface 131 with the inlet lower surface 110 and the inlet upper surface 120 interposed therebetween. More specifically, the second inlet lateral surface 132 may be formed at an upper side of the inlet region IR and formed in parallel with the inlet region IR.

In this case, unlike the first inlet lateral surface 131 including the curved shape, the second inlet lateral surface 132 may include a flat shape. More particularly, the second inlet lateral surface 132 is formed in a flat shape. Like the first inlet lateral surface 131, the second inlet lateral surface 132 is also configured to connect the inlet lower surface 110 and the inlet upper surface 120, such that shapes of the upper and lower ends of the first inlet lateral surface 131 may also correspond thereto. More specifically, the upper end of the second inlet lateral surface 132 may include a section having a gradient that increases as the section becomes closer to the heat exchange member 200. More specifically, the upper end of the second inlet lateral surface 132 may include a section having a gradient that increases as the section becomes closer to the heat exchange member 200, and a section extending in the horizontal direction.

Meanwhile, the first inlet lateral surface 131 and the second inlet lateral surface 132 may be connected to each other. More specifically, the other end of the second inlet lateral surface 132, which is opposite to one end facing the heat exchange member 200, may be connected to the first inlet lateral surface 131.

Meanwhile, for example, according to the first embodiment of the present disclosure, the inlet lower surface 110 may include a flat shape or be formed in the flat shape.

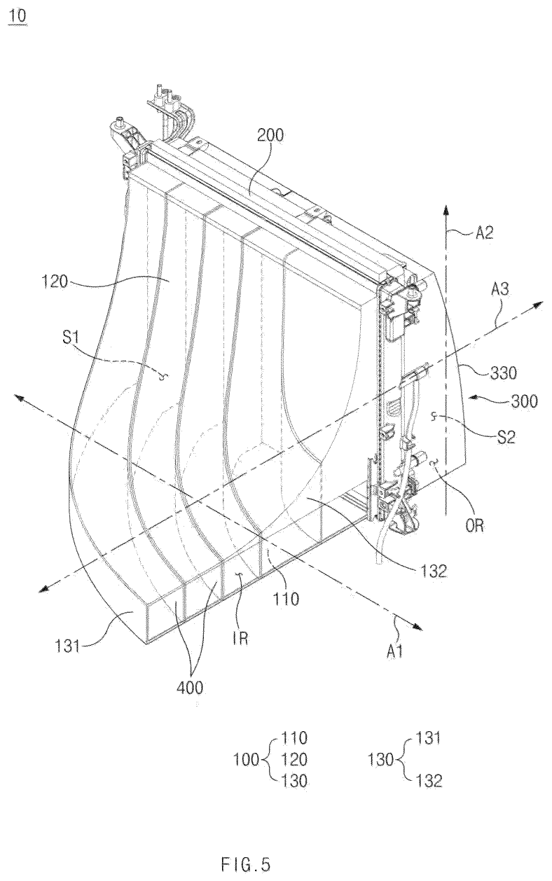

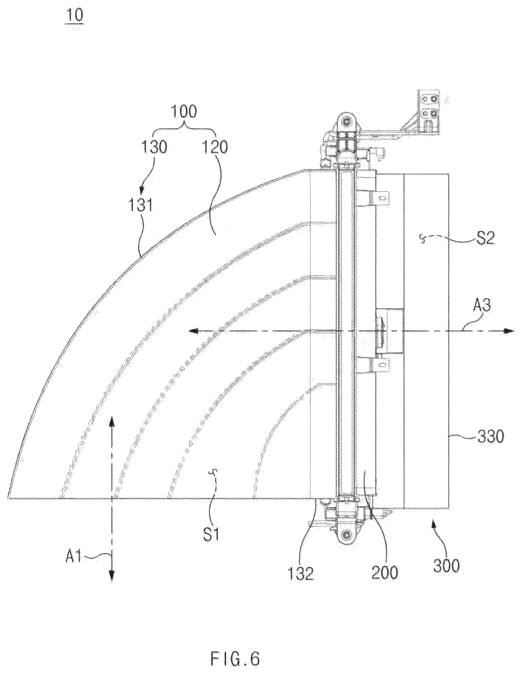

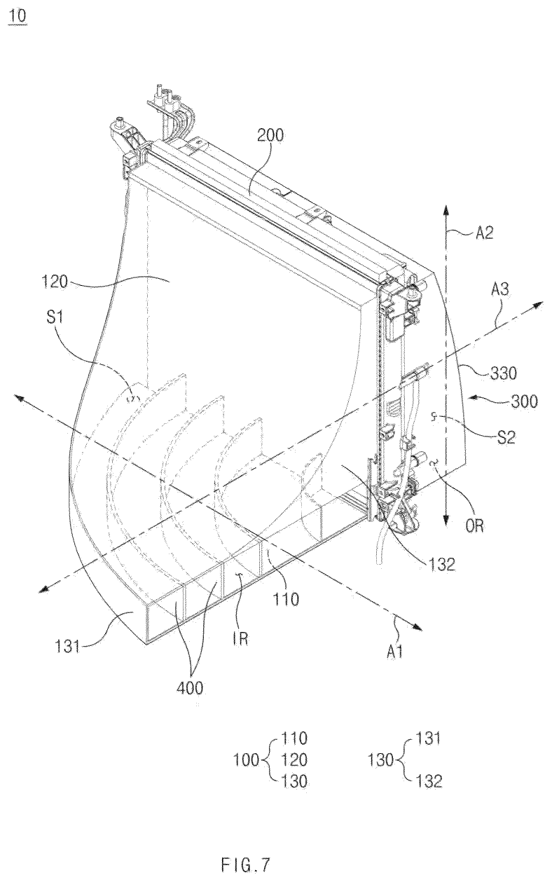

FIG. 5 is a perspective view of a cooling device according to a second embodiment of the present disclosure, and FIG. 6 is a top plan view of the cooling device according to the second embodiment of the present disclosure. FIG. 7 is a perspective view of a cooling device according to a third embodiment of the present disclosure.

The cooling device 10 according to the second and third embodiments of the present disclosure differs from the cooling device according to the first embodiment of the present disclosure in that the cooling device 10 further includes a division wall member to be described below. However, the above-mentioned description of the contents of the first embodiment of the present disclosure may be applied, in an intact manner, to the other components excluding the division wall member.

With reference to FIGS. 5 to 7, the cooling device 10 may further include one or more division wall members 400 provided inside the inlet body 100 and protruding upward from the inlet lower surface 110. More particularly, the division wall members 400 may be provided as a plurality of division wall members 400. For example, FIGS. 5 to 7 illustrate that three division wall members 400 are provided.

The division wall members 400 may be configured to form a plurality of regions by partitioning the inlet region IR and the first space S1 in the inlet body 100 in the horizontal direction. More specifically, the division wall member 400 may extend from the inlet region IR toward the heat exchange member 200.

According to the second and third embodiments of the present disclosure, the division wall member 400 may be configured to guide the outside air to the heat exchange member 200 while preventing the outside air from being concentrated in a partial space of the first space S1 during the process in which the outside air introduced into the first space S1 through the inlet region IR is introduced into the heat exchange member 200. For example, the division wall member 400 may extend in parallel with the first inlet lateral surface 131 so that the outside air in the first space S1 may be smoothly supplied to the heat exchange member 200.

Meanwhile, according to the second embodiment of the present disclosure, as illustrated in FIGS. 5 and 6, at least a part of the division wall member 400 may extend from the inlet lower surface 110 to the inlet upper surface 120. According to the third embodiment of the present disclosure, as illustrated in FIG. 7, at least a part of the division wall member 400 may extend from the inlet lower surface 110 and be spaced apart from the inlet upper surface 120. Alternatively, the division wall member 400 may include a section extending from the inlet lower surface 110 to the inlet upper surface 120, and a section extending from the inlet lower surface 110 and spaced apart from the inlet upper surface 120. For example, with reference to FIG. 7, a section of the division wall member 400, which is adjacent to the inlet region IR, may extend from the inlet lower surface 110 to the inlet upper surface 120, and a section of the division wall member 400, which is adjacent to the heat exchange member 200, may include a section extending from the inlet lower surface 110 and spaced apart from the inlet upper surface 120.

In the third embodiment of the present disclosure, a width of each of the division wall members 400 in the upward/downward direction may be constant, and the widths of the plurality of division wall members 400 in the upward/downward direction may be equal or correspond to one another.

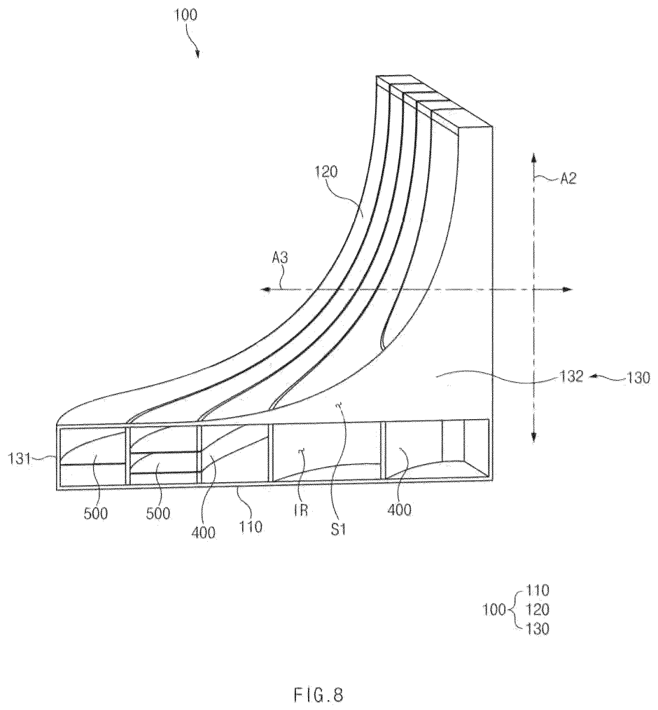

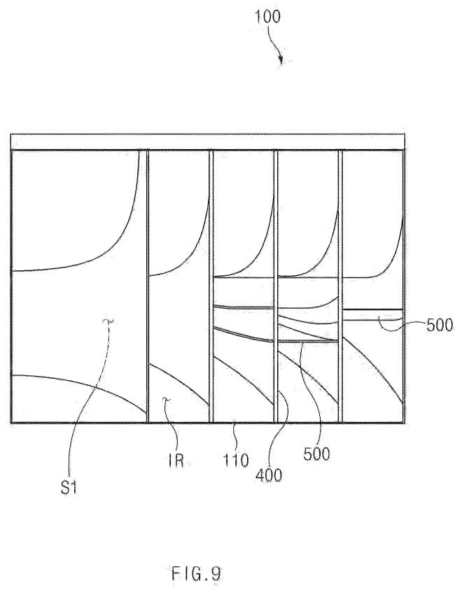

FIG. 8 is a perspective view of an inlet body provided in a cooling device according to a fourth embodiment of the present disclosure, and FIG. 9 is an enlarged view illustrating regions partitioned by partition members and division wall members of the inlet body provided in the cooling device according to the fourth embodiment of the present disclosure.

The cooling device 10 according to the fourth embodiment of the present disclosure differs from the cooling device according to the second and third embodiments of the present disclosure in that the cooling device 10 further includes a partition member to be described below. However, the above-mentioned description of the contents of the second and third embodiments of the present disclosure may be applied, in an intact manner, to the other components excluding the partition member, and the above-mentioned description of the contents of the first embodiment of the present disclosure may be applied, in an intact manner, to the other components excluding the division wall member and the partition member.

With reference to FIGS. 8 and 9, the cooling device 10 according to the present disclosure may further include one or more partition members 500 extending from the division wall member 400 and configured to partition the first space S1 in the upward/downward direction. For example, the partition members 500 may be provided as a plurality of partition members 500.

Similar to the division wall member 400, the partition members 500 may be configured to form a plurality of regions by partitioning the inlet region IR and the first space S1 in the inlet body 100 in the upward/downward direction. More specifically, the partition member 500 may be connected to the two adjacent division wall members 400.

According to the fourth embodiment of the present disclosure, the division wall member 400 may be configured to guide the outside air to the heat exchange member 200 while preventing the outside air from being concentrated in a partial space of the first space S1 during the process in which the outside air introduced into the first space S1 through the inlet region IR is introduced into the heat exchange member 200. In particular, according to the fourth embodiment of the present disclosure compared to the second and third embodiments of the present disclosure, the division wall member 400 and the partition member 500 are provided together, the inlet region IR and the first space S1 may be partitioned not only in the upward/downward direction but also in the horizontal direction, such that the flow path for outside air may be further segmentalized in the inlet body 100.

Meanwhile, according to the fourth embodiment of the present disclosure, a cross-section, which is made by cutting the partition member 500 in the direction perpendicular to the first normal direction A1, may have a line segment shape. In addition, when the partition member 500 is viewed from a position spaced apart from the partition member 500 in the first normal direction A1, the partition member 500 may include a curved shape recessed downward and toward the heat exchange member 200 or be formed in the curved shape.

Meanwhile, with reference back to FIGS. 2 to 7, the outlet body 300 of the cooling device 10 according to the present disclosure may include an outlet lateral surface 330 configured to define a lateral surface of the outlet body 300. For example, the outlet lateral surface 330 may have a shape convex outward. More specifically, a cross-section, which is made by cutting the outlet lateral surface 330 in the direction perpendicular to the first normal direction A1, may include a curved shape convex outward or be formed in the curved shape. A cross-section, which is made by cutting the outlet lateral surface 330 perpendicularly to the facing direction A3, may include a line segment shape or an assembly of the line segment shapes (e.g., a rectangular shape).

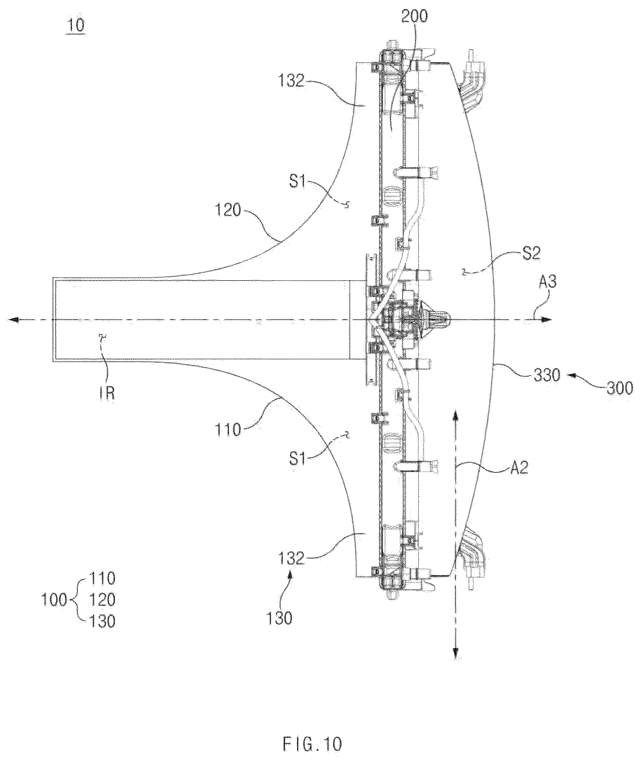

FIG. 10 is a front view of a cooling device according to a fifth embodiment of the present disclosure.

The cooling device 10 according to the fifth embodiment of the present disclosure differs from the cooling device according to the first embodiment of the present disclosure in terms of a shape of the inlet lower surface 110. However, the above-mentioned description of the contents of the first embodiment of the present disclosure may be applied, in an intact manner, to the other components excluding the shape of the inlet lower surface 110.

According to the fifth embodiment of the present disclosure, the inlet lower surface 110 of the inlet body 100 may include a shape recessed toward the first space S1 or be formed in a recessed shape. For example, as illustrated in FIG. 10, the inlet lower surface 110 and the inlet upper surface 120 may have symmetric shapes with the inlet region IR interposed therebetween. In addition, the outlet lateral surface 330 of the outlet body 300 may also have a symmetric shape with respect to the upward/downward direction.

Meanwhile, according to the present disclosure, the inlet region IR needs to have a predetermined size or larger to supply sufficient outside air to the cooling device 10. For example, an area of the inlet region IR may be 20% or more of an area of a region in which the outside air is introduced from the heat exchange member 200 and the heat exchange is substantially performed. In case that the area of the inlet region IR is less than 20% of the area of the region in which the outside air is introduced from the heat exchange member 200 and the heat exchange is substantially performed, the outside air cannot be sufficiently supplied to the cooling device, and the heat exchange cannot be smoothly performed in the heat exchange member.

### Vehicle

With reference to FIG. 1 and the like, the vehicle 20 according to the present disclosure may include a frame 50 on which the cooling device 10 and the cooling device 10 are mounted. All the above-mentioned contents related to the cooling device according to the present disclosure may be applied to the cooling device 10 provided in the vehicle 20 according to the present disclosure.

For example, the cooling device 10 provided in the vehicle 20 may be disposed in a front region of the vehicle. More specifically, the cooling device 10 may include the inlet body 100 including the inlet region IR, which is opened toward the outside, and having therein the first space S1 that communicates with the inlet region IR, the heat exchange member 200 provided at one side of the inlet body 100 and having the heat exchange region that communicates with the first space S1, and the outlet body 300 provided at one side of the heat exchange member 200, having therein the second space S2 configured to communicate with the heat exchange region, and including the outlet region OR opened toward the outside.

Meanwhile, the inlet body 100 of the cooling device 10 provided in the vehicle 20 according to the present disclosure may include the region recessed toward the first space S1. The recessed region of the inlet body 100 may be provided to face the central region of the frame 50 based on the leftward/rightward direction. The outlet body 300 may be provided to face the outer region of the frame 50 based on the leftward/rightward direction.

In addition, the inlet region IR may be provided to be directed toward the front side of the vehicle 20, the heat exchange member 200 may be provided to be directed toward the left or right side of the vehicle 20, and the outlet region OR may be provided to be directed downward.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A cooling device comprising:
an inlet body including an inlet region, which is opened toward an outside of the vehicle, and having therein a first space that communicates with the inlet region;
a heat exchange member provided at one side of the inlet body and having a heat exchange region that communicates with the first space; and
an outlet body provided at one side of the heat exchange member, having therein a second space configured to communicate with the heat exchange region, and including an outlet region opened toward the outside,
wherein a direction extending perpendicularly to an imaginary plane formed in parallel with the inlet region is defined as a first normal direction, a direction extending perpendicularly to an imaginary plane formed in parallel with the outlet region is defined as a second normal direction, and a direction in which the heat exchange member faces the inlet body or the outlet body is defined as a facing direction, and
wherein the first normal direction, the second normal direction, and the facing direction intersect one another.

2. The cooling device of claim 1, wherein the inlet body includes a region recessed toward the first space.

3. The cooling device of claim 1, wherein the inlet body and the outlet body are provided to face each other with the heat exchange member interposed therebetween.

4. The cooling device of claim 1, wherein a direction perpendicular to the first normal direction and the facing direction is defined as an upward/downward direction,
wherein the inlet body includes:
an inlet lower surface configured to define a lower surface of the inlet body;
an inlet upper surface provided to be spaced apart upward from the inlet lower surface; and
an inlet lateral surface configured to connect the inlet lower surface and the inlet upper surface, and
wherein the inlet lateral surface includes a first inlet lateral surface including a shape convexly protruding outward.

5. The cooling device of claim 4, wherein the inlet upper surface includes a shape recessed toward the first space.

6. The cooling device of claim 5, wherein a cross-section, which is made by cutting the inlet upper surface in a direction perpendicular to the first normal direction, includes a curved shape recessed inward or a line segment shape.

7. The cooling device of claim 4, wherein an upper end of the first inlet lateral surface includes a section having a gradient that increases as the section becomes closer to the heat exchange member.

8. The cooling device of claim 4, wherein the inlet lateral surface further includes a second inlet lateral surface provided to face the first inlet lateral surface with the inlet upper surface interposed therebetween, and
wherein the second inlet lateral surface includes a flat shape.

9. The cooling device of claim 8, wherein the other end of the second inlet lateral surface, which is opposite to one end facing the heat exchange member, is connected to the first inlet lateral surface.

10. The cooling device of claim 4, further comprising:
one or more division wall members provided inside the inlet body and protruding upward from the inlet lower surface,
wherein the division wall member extends from the inlet region toward the heat exchange member.

11. The cooling device of claim 10, wherein the division wall member extends in parallel with the first inlet lateral surface.

12. The cooling device of claim 10, wherein the division wall member extends from the inlet lower surface to the inlet upper surface.

13. The cooling device of claim 10, wherein the division wall member extends from the inlet lower surface and is provided to be spaced apart from the inlet upper surface.

14. The cooling device of claim 10, wherein the division wall member includes:
a section extending from the inlet lower surface to the inlet upper surface; and
a section extending from the inlet lower surface and provided to be spaced apart from the inlet upper surface.

15. The cooling device of claim 13, wherein a width of the division wall member in the upward/downward direction is constant.

16. The cooling device of claim 10, further comprising:
a partition member extending from the division wall member and configured to partition the first space in the upward/downward direction.

17. The cooling device of claim 1, wherein the outlet body includes an outlet lateral surface configured to define a lateral surface of the outlet body, and
wherein the outlet lateral surface includes a shape convex outward.

18. The cooling device of claim 5, wherein the inlet lower surface includes a shape recessed toward the first space.

19. A vehicle comprising the cooling device of claim 1.

20. A vehicle comprising:
a cooling device; and
a frame on which the cooling device is mounted,
wherein the cooling device comprises:
an inlet body including an inlet region, which is opened toward an outside of the vehicle, and having therein a first space that communicates with the inlet region;
a heat exchange member provided at one side of the inlet body and having a heat exchange region that communicates with the first space; and
an outlet body provided at one side of the heat exchange member, having therein a second space configured to communicate with the heat exchange region, and including an outlet region opened toward the outside,
wherein the inlet body includes a region recessed toward the first space, and
wherein the recessed region of the inlet body is provided to face a central region of the frame based on a leftward/rightward direction.
